(19) United States
(12) Patent Application Publication
(10) Pub. No.: US 2008/0074833 A1
(43) Pub. Date: Mar. 27, 2008

(54) Rereconfigurable structure for panel of portable personal computer

(75) Inventors: Leo Ming Tz Chien, Taipei City (TW); Chia-Shyong Cheng, Taipei City (TW); Yu-Min Fang, Taipei City (TW); Hou-Chih Lee, Taipei City (TW); Yi-Chan Tseng, Taipei City (TW)

Correspondence Address: BRUCE H. TROXELL, SUITE 1404, 5205 LEESBURG PIKE, FALLS CHURCH, VA, 22041, US

(73) Assignee: First International Computer, Inc.

(21) Appl. No.: 11/798,054

(22) Filed: May 9, 2007

(30) Foreign Application Priority Data
May 19, 2006 (TW) 095117891

(51) Int. Cl. G06F 1/16

(52) U.S. Cl. 361/683

(57) ABSTRACT

A reconfigurable structure for a panel of a portable personal computer is adapted to allow the panel of a portable computer housing to be provided with an attachment surface; the panel and a cover plate are respectively provided with first pivotal connection portions and second pivotal connection portions capable of being pivotally connected to each other so as to allow the cover plate to be liftably fixed on the panel of the portable computer housing and an article to be held between the cover plate and the panel of the portable computer housing. Whereby, the outlook or the pattern of the panel of the computer can be changed to attain to the requirement that the outlook of the computer is matched up with a personalized desire.

### BACKGROUND OF THE INVENTION

1. Field of the Invention

The present invention relates to a panel of a housing of a portable personal computer, and more particularly to a reconfigurable structure for a panel of a portable computer.

2. Brief Description of Related Art

The functions of a portable computer are stronger recently and the portable convenience of the computer itself can feed consumers' purchasing appetite. A panel at the back of a display screen of a general portable computer is not always reconfigurable; a pattern thereon cannot be changed depending on a user's need or further coupled to other articles.

U.S. Pat. No. 6,125,033 discloses a reconfigurable enclosure panel for a mobile computer, it comprises an attachment plate having a first surface and a second surface, in which the first surface is adapted to couple to an outer surface of an enclosure portion of a chassis of the mobile computer opposing a display thereof and a panel housing that is coupled to the second surface of the attachment plate, the different panel housing can be changed depending on a user's need. The panel housing can have cosmetic and/or functional attributes. The panel housing can be made of a durable substance like transparent or color plastic or textile or stainless steel, or coupled to other electronic elements to constitute a solar source.

The patent mentioned above discloses sticking an attachment plate to panel housing, and then allowing the attachment plate to be coupled to an outer surface of an enclosure portion of a chassis of the mobile computer so as to meet a user's requirement to change the panel housing. But, the panel housing needs to be stuck to the attachment plate first and it can then be coupled to the computer chassis, the coupling structure thereof is rather complex and the production cost is rather consuming. Although it mentions that a gap exists between the attachment plate and the panel housing for allowing thin articles like photographs or documents to be placed in, the thin articles placed between the panel housing and the attachment plate are not easy to be changed after the housing panel is stuck to the attachment plate. Besides, a user easily sees portions of the attachment plate without the placed-in thin article through the transparent panel housing; this causes visual portions of the whole panel housing to be not artistic.

### SUMMARY OF THE INVENTION

For simplifying a reconfigurable structure for a panel of a portable personal computer and being convenient for changing thin articles placed on the panel, the present invention is proposed.

The main object of the present invention is to provide a reconfigurable structure for a panel of a portable computer, having a simple structure and capable of saving the production cost.

Another object of the present invention is to provide are configurable structure for a panel of a portable computer, being convenient for the panel of the computer to be changed with different modeling and pattern.

Still another object of the present invention is to provide a reconfigurable structure for a panel of a portable computer, being convenient for allowing a thin article to be placed on the panel and a different thin article to be changed.

Still another object of the present invention is to provide a reconfigurable structure for a panel of a portable computer, capable of providing a same type of computer with various profiles to a buyer, increasing the production and the sale amounts of a same basic type of product without needing manufacturing different profiles and modeling of products and saving the product cost greatly to increase the profit of a computer manufacturer.

For attaining to the objects mentioned above, a reconfigurable structure for a panel of a portable personal computer is adapted to couple to the panel of a portable computer housing, comprises:

the panel of portable computer housing is provided with an attachment surface indented downward; the attachment surface is extended to one flank side of the panel; two sides of the attachment surface of the panel are respectively provided with a first pivotal connection portion;

a cover plate, the dimension thereof is corresponding to the attachment surface; the cover plate is provided with two second pivotal connection portions respectively corresponding to the first pivotal connection portions; in which the first pivotal connection portions are respectively movably coupled to the second pivotal connection portions; the cover plate is positioned on the attachment surface of the panel so as to allowing a user to choose a desired cover plate and the cover plate to be liftably fixed on the panel of the portable computer housing. An outlook or pattern of the panel of the computer can be changed to attain to the personal requirement to the computer outlook. And, the computer with a same type and various outlooks is allowed to supply to different purchasers; this can save the production cost greatly and increase the profit of the computer manufacturer.

### BRIEF DESCRIPTION OF THE DRAWINGS

The present invention can be more fully understood by reference to the following description and accompanying drawings, in which:

FIG. 1 is a schematic view, showing a separation state of a reconfigurable structure for a panel of a portable computer of a first preferred embodiment according to the present invention;

FIG. 2 is a schematic view, showing a cover plate without being filled in with a thin article of a first preferred embodiment according to the present invention;

FIG. 3 is a perspective view, showing a use state of a reconfigurable structure for a panel of a portable computer of a first preferred embodiment according to the present invention;

FIG. 4 is a schematic view, showing a separation state of a reconfigurable structure for a panel of a portable computer of a second preferred embodiment according to the present invention;

FIG. 5 is a perspective view, showing a use state of a reconfigurable structure for a panel of a portable computer of a second preferred embodiment according to the present invention;

FIG. 6 is a schematic view, showing a separation state of a reconfigurable structure for a panel of a portable computer of a third preferred embodiment according to the present invention; and

FIG. 7 is a perspective view, showing a use state of a reconfigurable structure for a panel of a portable computer of a third preferred embodiment according to the present invention.

### DETAILED DESCRIPTION OF THE PREFERRED EMBODIMENTS

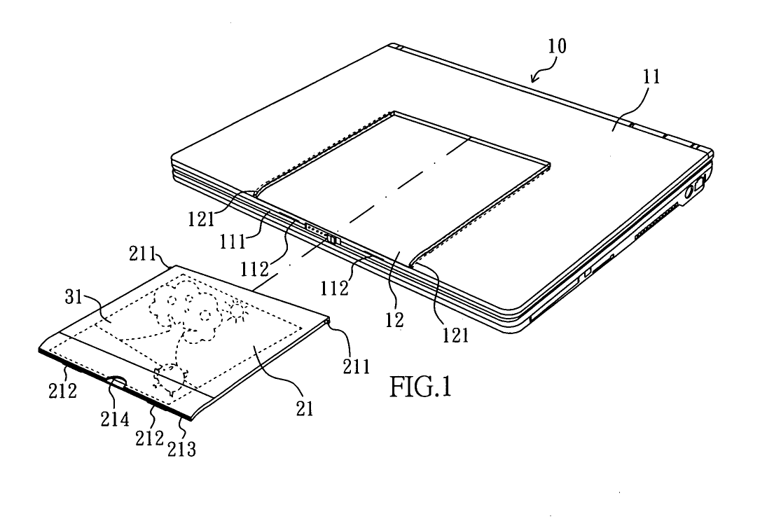

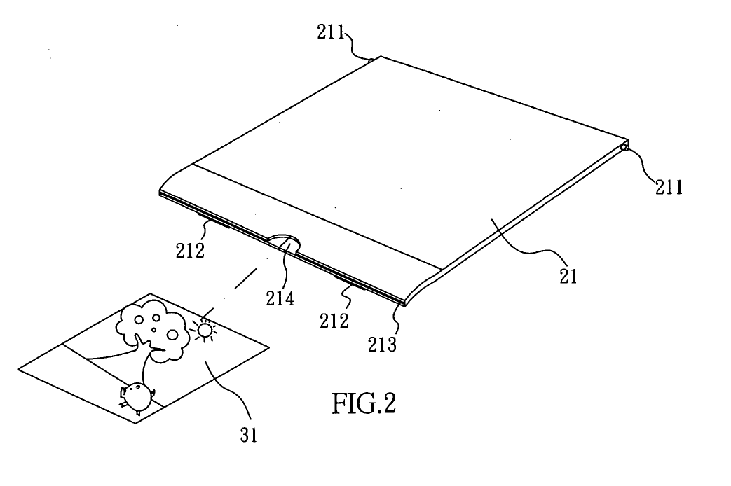

Please refer to FIGS. 1 and 2. A reconfigurable structure for a panel of a portable computer of a first preferred embodiment according to the present invention is adapted to couple to the panel of a portable computer housing and comprises a portable computer 10, a panel 11 at the back of a display screen of a housing thereof in which the panel 11 is provided with an attachment surface 12 indented downward. The attachment surface 12 is extended to one flank side 11 of the panel 11; a first pivotal connection portion such as guiding groove 121 is respectively disposed at two sides of the attachment surface 12 of the panel 11; at least one first buckling portion such as a buckling hole 112 is disposed on the flank side 111 of the panel 11; a cover plate 21 with a dimension corresponding to the attachment surface 12 is used for coupling to the panel 11; second pivotal connection portions such as pins 211 corresponding to the guiding grooves 121 are respectively disposed on two sides of the cover plate 21 and a second coupling portion such as buckling tenon 212 corresponding to the buckling hole 112 is disposed on the flank side of the cover plate 21. A slit chamber receiving space 213 used for accepting a thin article 31 such as graph or document is disposed in the cover plate 21. Besides, an indented-inward arc indentation 214 is disposed at an opening of the receiving space 213 so as to be convenient for a user to take out the thin article 31 through the arc indentation 214.

Please refer to FIGS. 1, 2 and 3. When the present embodiment is put into practice, the thin article 31 such as picture or document is placed into the receiving space 213 through the opening of the receiving space 213 of the cover plate 21 as FIG. 2 shows. And then, the pins 211 on two sides of the cover plate 21 are respectively inserted into the guiding grooves 121 of the panel 11 to cause the cover plate 21 to be placed on the attachment surface 12, and the cover plate 21 is then moved to allow the buckling tenon 212 to be engaged with the buckling hole 112 such that the cover plate 21 is allowed to couple to the attachment surface 12.

The cover plate 21 of the present embodiment can be a transparent plate, be provided with different length and width capable of matching up with the dimension of the attachment surface 12, or allow a brand name or trademark to be disposed on the cover plate 21. After the cover plate 21 is fixed on the panel 11, the pattern is exposed through the transparent cover plate 21 depending on the pattern placed-in thin article 31 or the cover plate 21 is provided with a different decoration pattern to allow an outlook of a housing of the portable computer 10 to be formed with a different modeling or pattern. The cover plate 21 of the present embodiment can also be provided with a writable and erasable plate such as a whiteboard to offer a user an erasable writing plate surface.

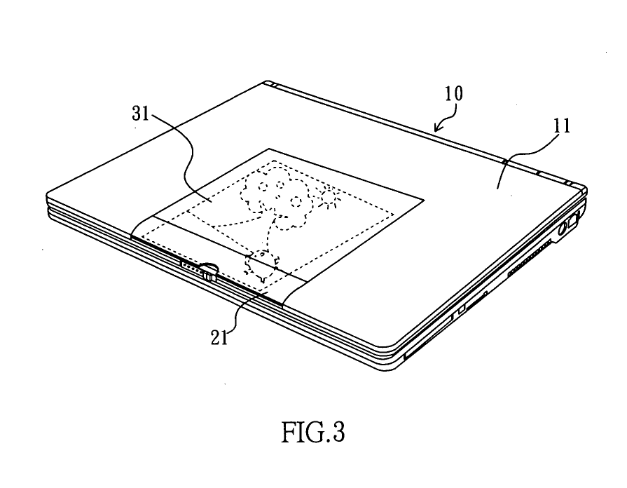

Please refer to FIGS. 2 and 3. According to the present embodiment, the thin article 31 such as picture or document can be placed in the receiving space 213 of the cover plate 21 and can be taken out anytime conveniently so as to allow the different thin article 31 to be changed to attain to the personalized change requirement or the different cover plate 21 to be replaced to match up with the requirement of a different purchaser.

According to the present embodiment, the cover plate 21 is conveniently coupled onto the panel 11. The portable computer 10 is allowed to provide with a different personalized style of modeling of the panel to attain to the outlook changing effect by means of a design of the cover plate 21 with a different pattern.

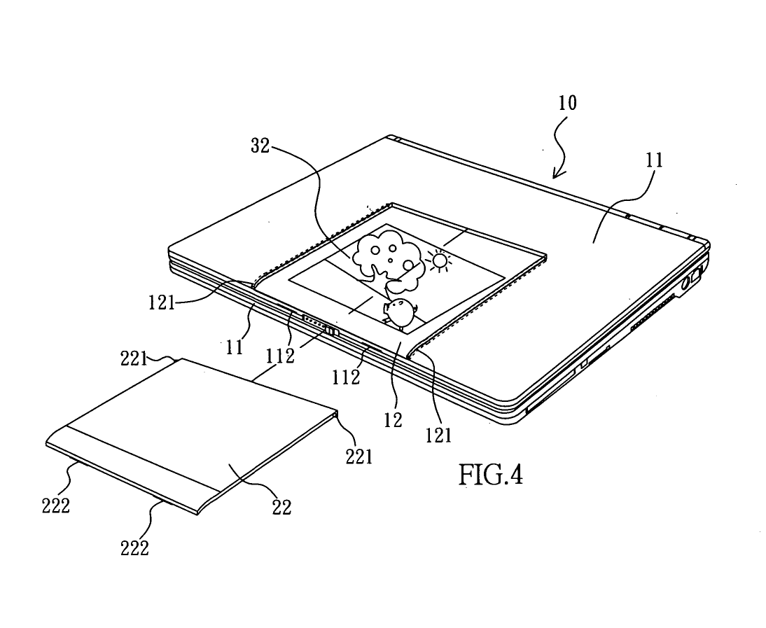

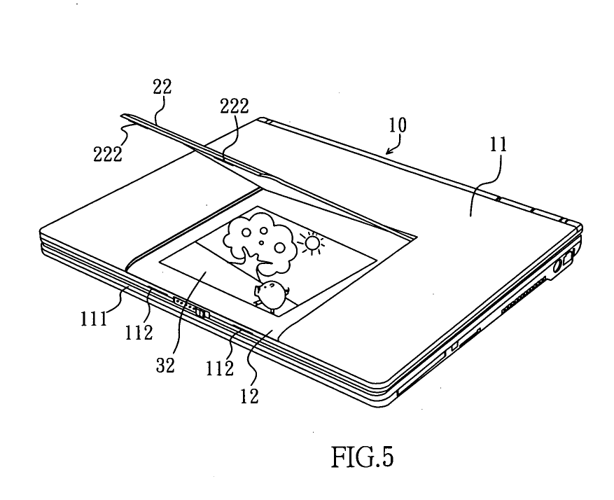

Please refer to FIGS. 4 and 5. A reconfigurable structure for a panel of a portable computer of a second preferred embodiment according to the present invention is adapted to couple to the panel of a portable computer housing and comprises a portable computer 10, a panel 11 at the back of a display screen of a housing thereof in which the panel 11 is provided with an attachment surface 12 indented downward. The attachment surface 12 is extended to one flank side 111 of the panel 11; a first pivotal connection portion such as guiding groove 121 is respectively disposed at two sides of the attachment surface 12 of the panel 11; at least one first buckling portion such as buckling hole 112 is disposed on the flank side 111 of the panel 11; a cover plate 22 with a dimension corresponding to the attachment surface 12 is used for coupling to the panel 11; second pivotal connection portions such as pins 221 corresponding to guiding grooves 121 are respectively disposed on two sides of the cover plate 22 and a second coupling portion such as buckling tenon 222 corresponding to the buckling hole 112 is disposed on a flank side of the cover plate 22.

When the present embodiment is put into practice, a thin article 32 such as picture or document can be placed on the attachment surface 12 of the panel 11 of the portable computer 10, the pins 221 at the two side of the cover plate 22 are respectively then allowed to placed into the guiding grooves 121 of the panel 11 to cause the cover plate 22 to be positioned on the attachment surface 12 and the cover plate 22 is further moved to cause the buckling tenon 222 to be engaged into the buckling hole 112, the cover plate 22 can then be allowed to couple to the attachment surface 12. A slit exists between the cover plate 22 and the attachment surface 12 and the thin article 32 is sandwiched between the cover plate 22 and the attachment surface 12. The material of the cover plate 22 of the present embodiment and the contents disposed thereon are the same as the cover plate 21 in the first embodiment; this also allows the portable computer 10 to have the effect of modeling of the panel 11 with a different personalized style. Besides, because the pins 221 at two sides of the cover plate 22 are respectively received in the guiding grooves 121 of the panel 11 in the present embodiment, the cover plate 22 can be allowed to take the pins 221 to be an axis to be pivotally connected to the panel 11; this allows a user to lift the cover plate 22 conveniently to replace the thin article 32 as FIG. 5 shows.

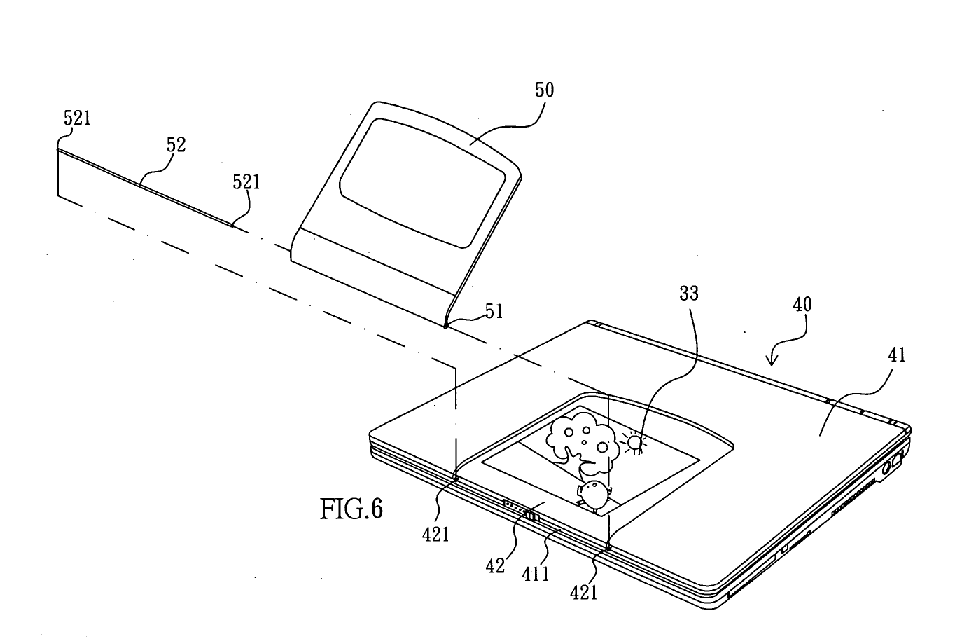

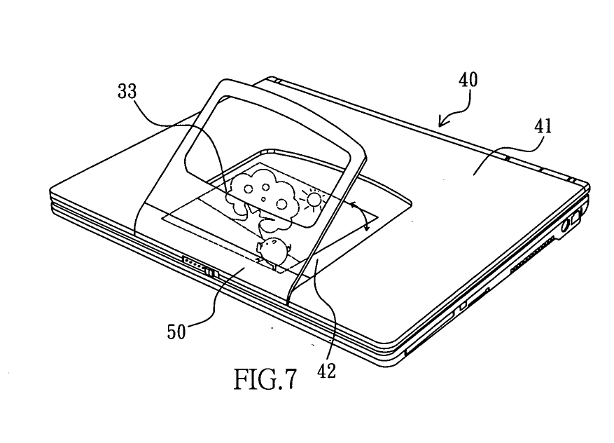

Please refer to FIGS. 6 and 7. A reconfigurable structure for a panel of a portable computer of a third preferred embodiment according to the present invention is adapted to couple to the panel of a portable computer housing and comprises a portable computer 40, a panel 41 at the back of a display screen of a housing thereof in which the panel 41 is provided with an attachment surface 42 indented downward. The attachment surface 42 is extended to one flank side 411 of the panel 11; a first pivotal connection portion such a pivotal connection hole 421 is respectively disposed on positions respectively at two sides of the attachment surface 42 of the panel 41 close to the flank side 411; a cover plate 50 with a dimension corresponding to the attachment surface 42 is used for coupling to the panel 41; a second pivotal connection portions such as a pins 521 corresponding to pivotal connection holes 421 are respectively disposed on two sides of the cover plate 50. Two pivotal connection holes 51 are respectively disposed on two sides of the cover plate 50. The pivotal connection holes 51 are pivotally connected to a shaft 52; two ends of the shaft 52 extended out of the pivotal connection holes 51 to form the pins 521. Because the shaft 52 is elastic, it can be bended slightly to allow both ends thereof to be respectively inserted into the pivotal connection holes 51 and 421 to enable one end of the cover plate 50 to be pivotally connected to the panel 41.

Please refer to FIGS. 6 and 7. When the present embodiment is put into practice, a thin article 33 such as picture or document can be placed on the attachment surface of the panel 41 of the portable computer 40, the pins 521 at two sides of the cover plate 50 are then respectively inserted into the pivotal connection holes 421 of the panel 11. Thereafter, the cover plate 50 is allowed to be pivotally connected to the panel 41 and then to position on the attachment surface 42. The material of the cover plate 50 of the present embodiment and the contents disposed thereon are the same as the cover plate 21 in the first embodiment; this also allows the portable computer 40 to have the effect of modeling of the panel 41 with a different personalized style. Besides, because the pins 521 at two sides of the cover plate 50 are respectively pivotally connected to the pivotal connection holes 421 of the panel 41 in the present embodiment, the cover plate 50 is allowed to take the pins 521 to be an axis to be pivotally connected to the panel 41; this allows a user to lift the cover plate 50 conveniently to replace the thin article 33

A reconfigurable structure for a panel of a portable computer disclosed in the present invention allows an outlook, pattern or material of the panel of the computer to be changed to attain to the requirement the outlook of the computer is matched up with the personalized desire so as to stimulate consumers' desire to purchase. Besides, a computer manufacturer can provide different purchaser with a same type of computer with different outlooks by means of the reconfigurable structures for a panel of a portable computer disclosed in the present invention. this is also to say that only changing a cover plate or a place-in pattern can change the outlook to attain to the growth of the production and the sale amounts of a same fundamental type of product without needing to respectively manufacture different outlook and modeling of products so as to be able to save the production cost greatly and increase the profit of the computer manufacturer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reconfigurable structure for a panel of a portable personal computer, adapted to couple to said panel of a portable computer housing and comprising:
said panel of said portable computer housing having an attachment surface indented downward; said attachment surface being extended to on flank side of said panel;
said panel having first pivotal connection portions respectively on two sides of said attachment surface;
a cover plate, a dimension thereof being corresponding to said attachment surface; said cover plate having two second pivotal connection portions respectively corresponding to said first pivotal connection portions;
wherein said first pivotal connection portions and said second movable portions are respectively coupled to each other; said cover plate is positioned on said attachment surface of said panel; whereby, a user is allowed to choose a required cover plate, and said cover plate is allowed to be liftably fixed on said panel of said portable computer housing.

2. The reconfigurable structure for a panel of a portable personal computer according to claim 1, wherein said first pivotal connection portions and said second pivotal connection portions respectively are guiding grooves and pins corresponding to each other.

3. The reconfigurable structure for a panel of a portable personal computer according to claim 2, wherein at least one first buckling portion is disposed on said flank side of said panel; a second buckling portion corresponding to said first coupling portion is disposed on said cover plate; whereby, said first and said second buckling portions are further allowed to engage with each other.

4. The reconfigurable structure for a panel of a portable personal computer according to claim 1, wherein said cover plate is a transparent plate; said cover plate is provided with a receiving space used for receiving a thin article.

5. The reconfigurable structure for a panel of a portable personal computer according to claim 4, wherein an indented inward indentation is disposed at an opening of said receiving space of said cover plate; whereby, a user is allowed to take out said thin article placed in the receiving space through said indentation.

6. The reconfigurable structure for a panel of a portable personal computer according to claim 1, wherein said cover plate is a transparent plate; a slit exists between said cover plate and said attachment surface; whereby, said slit is used to allow a thin article to be held between said cover plate and said panel.

7. The reconfigurable structure for a panel of a portable personal computer according to claim 1, wherein said cover plate is provided with a writable and erasable plate surface so as to offer a user an erasable writing plate surface.

8. The reconfigurable structure for a panel of a portable personal computer according to claim 1, wherein said panel is provided with said first pivotal connection portions respectively on positions at two sides of said attachment surface close to said flank side.

9. The reconfigurable structure for a panel of a portable personal computer according to claim 8, wherein said first pivotal connection portion and said second pivotal connection portion respectively are a pivotal connection hole and a pin corresponding to each other.

10. The reconfigurable structure for a panel of a portable personal computer according to claim 9, wherein said two pivotal connection holes are respectively disposed on two side of said cover plate; said second pivotal connection portions of said cover plate are pins formed by passing two ends of a shaft respectively through and extending said ends respectively out of said pivotal connection holes on two side of said cover plate.

11. The reconfigurable structure for a panel of a portable personal computer according to claim 10, wherein said shaft is elastic so as to be bended slightly to allow two ends of said shaft respectively to be inserted into said pivotal connection holes of said cover plate and said pivotal connection holes of said panel to enable one end of said cover plate to be pivotally connected to said panel.

12. The reconfigurable structure for a panel of a portable personal computer according to claim 8, wherein said cover plate is a transparent plate; a slit exists between said cover plate and said attachment surface; whereby, said slit is used to allow a thin article to be held between said cover plate and said panel.

13. The reconfigurable structure for a panel of a portable personal computer according to claim 9, wherein said cover plate is a transparent plate; a slit exists between said cover plate and said attachment surface; whereby, said slit is used to allow a thin article to be held between said cover plate and said panel.

14. The reconfigurable structure for a panel of a portable personal computer according to claim 10, wherein said cover plate is a transparent plate; a slit exists between said cover plate and said attachment surface; whereby, said slit is used to allow a thin article to be held between said cover plate and said panel.

15. The reconfigurable structure for a panel of a portable personal computer according to claim 11, wherein said cover plate is a transparent plate; a slit exists between said cover plate and said attachment surface; whereby, said slit is used to allow a thin article to be held between said cover plate and said panel.

16. The reconfigurable structure for a panel of a portable personal computer according to claim 8, wherein said cover plate is provided with a writable and erasable plate surface so as to provide a user with an erasable writing plate surface.

17. The reconfigurable structure for a panel of a portable personal computer according to claim 9, wherein said cover plate is provided with a writable and erasable plate surface so as to provide a user with an erasable writing plate surface.

18. The reconfigurable structure for a panel of a portable personal computer according to claim 10, wherein said cover plate is provided with a writable and erasable plate surface so as to provide a user with an erasable writing plate surface.

19. The reconfigurable structure for a panel of a portable personal computer according to claim 11, wherein said cover plate is provided with a writable and erasable plate surface so as to provide a user with an erasable writing plate surface.
